(19) United States
(12) Patent Application Publication
(10) Pub. No.: US 2015/0248255 A1
(43) Pub. Date: Sep. 3, 2015

(54) METHOD FOR SECURED USE OF TRANSPORTABLE DATA STORAGE MEDIA IN CLOSED NETWORKS

(71) Applicants: Ulf Feistel, Jena (DE); Steffen Feistel, Jena (DE)

(72) Inventors: Ulf Feistel, Jena (DE); Steffen Feistel, Jena (DE)

(21) Appl. No.: 14/422,789

(22) PCT Filed: Aug. 21, 2013
(86) PCT No.: PCT/DE2013/100301

§ 371 Date: May 18, 2015

(30) Foreign Application Priority Data
Aug. 21, 2012 (DE) 10 2012 107 683.9

(51) Int. Cl. G06F 3/06

(52) U.S. Cl. CPC G06F 3/0647; G06F 3/0608; G06F 3/067

(57) ABSTRACT

The invention relates to a method for the secured use of transportable data storage media in a closed network. The invention further relates to a transportable data storage medium comprising a rewritable memory for use in a closed network and to a closed network. The closed network (1) formed of at least two data processing devices (2, 3) is contactable by a transportable data storage medium (4). In order to allow data exchange between the closed network (1) and the transportable data storage medium (4) only when the transportable data storage medium (4) is also authorised for use, respective programs (7, 8, 9) are installed on both the data processing devices (2, 3) and the transportable data storage medium (4), by means of which programs an identification data set (7.1) stored on the transportable data storage medium (4) can be found, checked, transmitted, compared with a comparison data set (9.1) and can be replaced by a new identification data set (7.2).

The invention relates to a method for secure use of portable data storage devices in closed computer networks (henceforth: network). The invention also relates to a portable data storage device and to a closed network for implementing the method according to the invention.

A network is understood below to mean at least two data processing devices that are connected to one another via at least one communications channel. The data processing devices are preferably computers. These can be in the form of PCs but also can be formed by internal processing units of other devices, for example of analysis instruments or data playback devices.

A network is closed when it has no communications channels, or no open communications channels, to other networks, and access to the network is only possible via those data processing devices that are part of the network. Communications channels are, for example, drives, USB ports, fixed lines, wireless connections (e.g. Wireless LAN) or other data interfaces.

In closed networks of organizational units, for instance of companies, institutes, educational establishments or the like, “firewalls” are normally used to ensure protection from malicious software. With the current level of technology, these firewalls guarantee for the data processing devices that are part of a closed network a very high degree of protection from infection by malicious software such as computer viruses or Trojans, for example. All data that is unwanted in the closed network by the operator of the closed network is regarded below as malicious software or malware.

The greatest risk of installing malicious software unintentionally is currently through the use of personal portable data storage devices such as CDs or memory media, for instance the convenient and easy-to-carry USB stick. Through USB sticks that are infected with malicious software and used in networks, the malicious software can spread very quickly to numerous data processing devices. This malicious software can only be removed with a great deal of effort. The working time lost, in which the data processing devices cannot be used or even parts of the network are not available, is often considerable.

The malicious software tends to be brought into the closed networks on portable data storage devices, such as CDs and USB sticks, generally by personal files that are also stored on the portable data storage device.

Despite numerous different measures to prevent the use of such personal data storage devices, cases arise time and again in practice in which serious losses and damage are caused by imported malicious software.

Situations also arise occasionally in which business partners and cooperation partners provide customers or guests with portable data storage devices in order to exchange data. If these are infected with malicious software, the same problems arise as when using personal data storage devices infected with malicious software.

A core requirement when using portable data storage devices in closed networks is therefore to be able to check and assess the trustworthiness of the portable data storage device.

DE 10 2005 041 055 A1 discloses a method for improving the trustworthiness of an electronic device. The electronic device (data processing device) comprises a security module in which is stored device-specific data. User-specific data is stored in a portable data storage device. When a communications channel is opened between the data processing device and the portable data storage device, the device-specific data and the user-specific data are linked together. Only once the data has been linked together correctly is it possible to use the portable data storage device.

A similar approach is followed in a solution according to document US 2007/0074050 A1. A protected program is executed on a portable data storage device that is connected to a data processing device. The portable data storage device notifies the data processing device after execution of the protected program. An application can only run on the data processing device when the protected program is executed correctly.

The solutions known from the prior art, however, do not provide any protection against the unintentional import of malicious software into closed networks by the use of portable data storage devices.

Therefore the object of the invention is to propose a way of facilitating secure use of portable data storage devices in closed networks.

The object is achieved by a method for secure use of portable data storage devices in a closed network comprising at least two data processing devices connected to one another by communications channels. In this method, a first data processing device is a central computer of the closed network, and a second data processing device is a peripheral device.

Communication, that is to say the transfer of data and signals, between the first data processing device and the second data processing device takes place via a first communications channel. Communication between the second data processing device and a portable data processing device that is connected, if applicable, to the second data processing device takes place via a second communications channel.

A first data processing device in the sense of the description can be any computer that performs control functions via other components of the closed network (central computer). The first data processing device may be a personal computer, for example. It may also be formed, however, by processing units (typically CPUs or central processing units) of one or more data processing devices, which processing units are networked together for instance, wherein further existing processing units of the data processing devices can each act as second data processing devices of the closed network.

A second data processing device (peripheral device) is, for example, a personal computer, an analysis instrument (e.g. a meter or measuring apparatus) or a data playback device.

In a first step of the method according to the invention, a comparison data record is saved on the first data processing device, wherein the comparison data record comprises at least information about all the portable data storage devices approved for use at a current time, and the various items of information in the comparison data record can be compared with data in an identification data record.

The comparison data record can exist, for example, in the form of a table. It can also comprise information about portable data storage devices that were approved for use at an earlier time. The essential aspect is that the comparison data record is organized such that an explicit assignment of information to a portable data storage device is possible. The comparison data record is preferably stored such that the first data processing device can access the comparison data record. In addition, the comparison data record can preferably be modified by the first data processing device, e.g. by adding, removing and editing data.

An identification data record and a comparison data record can each be dedicated programs or parts of programs. These programs can be installed, for example, by an operator of the closed network, or else already be pre-installed on the components (data storage devices, data processing devices) of the closed network. If the identification data record is part of a program, the existence of the program containing the identification data record is preferably checked.

In a second step, an identification data record is saved on a portable data storage device, wherein identification features are added to the identification data record that individually characterize the portable data storage device. A change to the identification features results in a new identification data record.

Then the second communications channel is opened by establishing a connection of the portable data storage device to the second data processing device, for example via a standard data interface. Opening the second communications channel in this step of the method according to the invention is used by the second data processing device solely for checking the existence of the identification data record on the portable data storage device. Any transfer of data that goes beyond checking the existence of the identification data record does not take place at this time. This avoids transmitting unwanted data, for instance malware such as viruses or Trojans.

Preferably before opening the second communications channel, a communications program for communication of the second data processing device both with the first data processing device and with the portable data storage device is saved on the second data processing device. The communications program is saved on the second data processing device preferably by the first data processing device and via the first communications channel. The communications program is also used for checking the existence of the identification data record on the portable data storage device and, in the event that the identification data record does not exist on the portable data storage device, for closing the second communications channel.

It is assumed that in implementing the method according to the invention, a person skilled in the art can assign to the individual method steps and/or to the specified devices additional programs which are used to execute or support the described method steps.

In the next step of the method according to the invention, the existence of the identification data record on the portable data storage device is checked by the second data processing device, preferably by means of the communications program installed on the second data processing device. The correct configuration of the identification data record is equivalent to it existing. Thus, for example, an identification data record that exists but contains errors counts as nonexistent. The existence of the identification features (e.g. device-specific identifier and/or password) is preferably checked. In this step of the method, a decision is made as to whether or not an identification data record exists on the portable data storage device (binary or 1/0 decision). Two alternative routes for continuing the method according to the invention result from the decision: if an identification data record does not exist on the portable data storage device, the second communications channel between portable data storage device and second data processing device is closed, preferably by the second data processing device; if the check has established that an identification data record does exist on the portable data storage device, this result is recorded by the second data processing device.

In the next method step, the first data processing device is contacted via the first communications channel by the second data processing device by means of the communications program. Depending on the result of the check for the existence of an identification data record on the portable data storage device, either information about a nonexistence of the identification data record is transmitted and information about the closure of the second communications channel is transmitted to the first data processing device, or the identification data record, when it exists on the portable data storage device, is transmitted to the first data processing device.

If the identification data record exists, this is detected by the second data processing device via the second communications channel, and preferably captured as an electronic copy by the second data processing device. The second data processing device transmits the captured identification data record via the first communications channel to the first data processing device.

If the identification data record does not exist, information about the nonexistence of the identification data record and about the closure of the second communications channel is transmitted by the second data processing device via the first communications channel to the first data processing device.

The identification data record can consist solely of the identification features. In further embodiments of the invention, an identification data record can also contain additional data. Identification features are understood to mean such data that is used for unique assignment of a portable data storage device to data in the comparison data record. The identification features preferably comprise at least one identifier of the portable data storage device and a password. The password can be generated and allocated by the first data processing device.

The identification data record can be pre-installed on the portable data storage device. It is also possible for the identification data record to be saved on the portable data storage device when the portable data storage device is first connected to the second data processing device. In this case, the second data processing device detects that the identification data record does not exist and transmits the information about the nonexistence of the identification data record via the first communications channel to the first data processing device. Then the first data processing device passes to the second data processing device via the first communications channel an instruction to save an identification data record, and an identification record to be saved on the portable data storage device. The second data processing device receives this instruction and the identification data record to be saved, and opens the second communications channel such that it is possible to transfer between the portable data storage device and the second data processing device at least such data that is required for saving the identification data record on the portable data storage device. The second data processing device saves the identification data record on the portable data storage device. When a first connection is made, it is also possible for just the identification features to be transmitted by the first data processing device to the second data processing device, and to be saved from there on the portable data storage device.

The identification data record can be saved and protected on the portable data storage device in such a way that no changes to the identification data record are possible there. For example, a further security program may be required in order to be able to make changes to the identification data record. Such a security program can exist on an additional device, which is likewise to be contacted by the data processing device, for instance on a “dongle”.

If an identification data record has been transmitted to the first data processing device, this identification data record is compared with the comparison data record for congruence between said data records. Congruence here means that the compared data records do not necessarily have to be identical but must simply be related to each other in a specific way. In the step for checking for congruence, a 1/0 decision is again made, like that already made in the previous method step. If a congruence between the data records is established, a new identification data record is generated. This new identification data record contains new identification features, and is adopted in the comparison data record. In this process, the new identification data record can replace the previous identification data record or be saved in addition to the previous identification data record.

If, on the other hand, the first data processing device does not establish any congruence between the compared data records, then the first data processing device transmits via the first communications channel a blocking instruction to the second data processing device. The blocking instruction is executed by the second data processing device, whereby the second communications channel is closed by the second data processing device.

If the first data processing device established a congruence between the compared data records and generated and saved a new identification data record, the second communications channel is cleared for transmitting the new identification data record to the portable data storage device. This is preferably done by the first data processing device issuing information to the second data processing device via the first communications channel, as a result of which information the second data processing device clears the second communications channel for a transmission of the new identification data record to the portable data storage device.

The previous identification data record in the portable data storage device is replaced by the transmitted new identification data record. After the replacement, the second communications channel is cleared for a data transfer between portable data storage device and second data processing device.

It is possible to execute repeatedly the steps of the method that follow the step of saving (for the first time) the comparison data record on the first data processing device.

In a preferred embodiment of the method, all the procedures carried out in the stated method steps, for instance loading and/or transmitting data, can be logged and retrievably saved. It is also possible to log only specific procedures, for instance access attempts made by unauthorized portable data storage devices. It is also possible to save in a log, in addition to the procedures, information about, for instance, the time of day and duration of each of the procedures and about the data processing devices and/or data storage devices used.

A second and each further data processing device can be registered and authorized in the closed network by entering a password. It is then part of the closed network. When a new second data processing device is registered, the first data processing device checks whether the communications program is already installed on the second data processing device to be registered. If this is not the case, this communications program is installed automatically on the second data processing device by the first data processing device via the first communications channel.

In an advantageous embodiment of the method according to the invention, the communications program comprises a routine for detecting and removing malware. The routine for detecting and removing malware searches for malware in a portable data storage device contacted by the second data processing device via the second communications channel. If such malware is found, the found malware can be removed by the routine. Preferably, however, the second data processing device closes the second communications channel and transmits information about detecting the malware to the first data processing device. It can be provided that the portable data storage device is accepted by the first data processing device for implementing the method according to the invention once the malware has been removed.

The object is also achieved by a portable data storage device comprising a rewritable memory. The portable data storage device according to the invention is characterized in that an identification data record is stored in a retrievable and editable manner on the portable data storage device, which identification data record contains identification features that individually characterize the portable data storage device. The portable data storage device is not cleared for transmission of further data until a new identification data record is received and saved. This further data, for instance, is data that goes beyond the previous and the new identification data record.

The portable data storage device can be configured such that an existing identification data record permits use of the portable data storage device solely in a specific closed network.

The portable data storage device is preferably a USB stick (data storage device based on specifications 1.0, 2.0 and higher of the Universal Serial Bus system).

It is advantageous if a first program exists on the portable data storage device, which first program is used for communication with the second data processing device and contains an identification data record containing identification features that individually characterize the portable data storage device.

The object is also achieved by a closed network comprising at least two data processing devices connected to one another by communications channels, wherein a first data processing device is a central computer, and a second data processing device is a peripheral device. The closed network according to the invention is characterized in that on the second data processing device is installed a communications program:
i) for communication of the second data processing device with the first data processing device via a first communications channel, and with a portable data storage device connected via a second communications channel to the second data processing device,
ii) for checking the existence of an identification data record on the portable data storage device, and
iii) for closing the second communications channel in the event that the identification data record does not exist.

On the first data processing device is stored a second program, which is used:
iv) for communicating with the second data processing device,
v) for performing a comparison and a check for congruence at least of identification features in the identification data record that individually characterize the portable data storage device with a comparison data record saved in the first data processing device, wherein the comparison data record comprises at least information about all the portable data storage devices approved for use at the current time, and the various items of information in the comparison data record can be compared with data in an identification data record,
vi) for generating and providing new identification features when a congruence has been established, and
vii) for providing a blocking instruction to the second data processing device when congruence has not been established, wherein execution of the blocking instruction blocks the second communications channel between second data processing device and portable data storage device.

The communications program stored on the second data processing device can be suitable for identifying malware on portable data storage devices. In addition, it can be used to distinguish between data processing devices connected externally to the second data processing device and data storage devices in the sense that it checks whether the connected units are external hardware that does not contain data that can be changed by a user, or whether they are portable data storage devices containing data, at least part of which can be changed by a user. If external hardware is detected that solely contains data that cannot be changed by a user (e.g. a meter), a second communications channel is opened between second data processing device and external hardware.

In case third parties wish to provide unauthorized portable data storage devices for transferring the data contained thereon, the operator, owner, user etc. of the closed network can provide at least one independent data processing device, e.g. a PC or laptop, which is not connected to the closed network. The unauthorized portable data storage device can be connected to the independent data processing device, whereupon this device uses a diagnostic program to check data provided by the third-party for infection with malicious software. If the data is not infected, the independent data processing device saves this data on an authorized portable data storage device.

The invention is described in greater detail below with reference to exemplary embodiments and a drawing, in which:

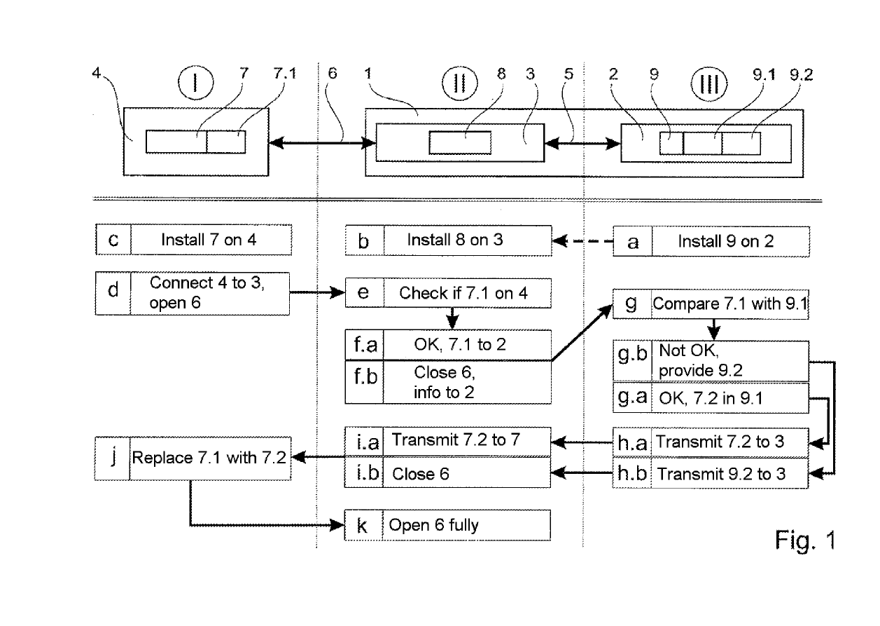

FIG. 1 is a general block diagram of the method according to the invention.

FIG. 1 shows schematically in the topmost line a closed network 1 having a central computer as a first data processing device 2, and a peripheral device as a second data processing device 3, which are connected together via a first communications channel 5. The FIGURE also shows a portable data storage device 4, which is given by a USB stick, which is connected to the second data processing device 3 via a second communications channel 6.

The portable data storage device 4 comprises a first program 7 (symbolized by a box), which is used for communication with the second data processing device 3 and which contains an identification data record 7.1 containing identification features that individually characterize the portable data storage device 4. The identification features are formed by a device-specific identifier and a password.

A communications program 8 is installed on the second data processing device 3 and is used for communication of the second data processing device 3 with the first data processing device 2 and with the portable data storage device 4. The communications program 8 can also be used to check the existence of an identification data record 7.1 on the portable data storage device 4. In the event that the identification data record 7.1 does not exist, the communications program 8 provides that the second communications channel 6 is closed by the second data processing device 3.

The first data processing device 2 has a second program 9 that is used to facilitate communication of the first data processing device 2 with the second data processing device 3 via the first communications channel 5. In addition, a comparison and a check for congruence at least of specific identification features in an identification data record 7.1 that individually characterize the portable data storage device 4 with a comparison data record 9.1 saved in the first data processing device 2 is possible, wherein the comparison data record 9.1 comprises at least information about all the portable data storage devices 4 approved for use at the current time, and the various items of information in the comparison data record 9.1 can be compared with data in an identification data record 7.1. In addition, the second program 9 can generate and provide new identification features when a congruence between the data records 7.1, 9.1 has been established. The second program 9 can provide a blocking instruction 9.2 to the second data processing device 3 when congruence has not been established. By the second data processing device 3 executing the blocking instruction 9.2, the second data processing device 3 blocks the second communications channel 6.

Beneath the dashed horizontal line, FIG. 1 also shows schematically an embodiment of the method according to the invention. The FIGURE shows vertically below each component of the closed network 1 (first and second data processing device 2, 3) and below the portable data storage device 4, in the columns I, II, III, those method steps that are assigned to the respective components of the closed network 1 that lie above and to the portable data storage device 4.

Thus column I shows in simplified form the method steps that essentially are performed by the portable data storage device 4 and the first program 7. Column II shows those method steps that are assigned to the second data processing device 3 and the communications program 8, and column III illustrates the method steps that are performed by the first data processing device 2 and the second program 9.

The method according to the invention shall be explained in greater detail below with reference to FIG. 1.

First, the first program 7 is saved on the portable data storage device 4 (block c), the second program 9 on the first data processing device 2 (block a), and the communications program 8 on the second data processing device 3 (block b). The dashed-line arrow between block a and b indicates that the installation of the communications program 8 on the second data processing device 3 can also be performed by the first data processing device 2 via the first communications channel 5.

Once the first and second programs 7 and 9 and the communications program 8 have been saved on the respective portable data storage devices 4 and the data processing devices 2, 3 (blocks a to c), the transportable data storage device 4 can be connected to the second data processing device 3 (block d). The second communications channel 6 is opened by virtue of the connection, and the communications program 8 checks as to whether an identification data record 7.1 exists on the portable data storage device 4. The identification data record 7.1 is also examined in terms of its correct structure (block e). At this point in time, the second communications channel 6 is solely open for the transfer of that data that is used to check the existence of the identification data record 7.1.

If it is established that an identification data record 7.1 exists, the communications program 8 contacts the first data processing device 2 via the first communications channel 5, and transmits the identification data record 7.1 to the first data processing device 2 (block f, alternative f.a). There, the identification data record 7.1 is compared with the comparison data record 9.1 (block g). In this process, identification features contained in the identification data record 7.1 are compared with data in the comparison data record 9.1 and are checked as to whether there is congruence between the identification features and the data in the comparison data record 9.1. After establishing a congruence between the data records 7.1 and 9.1, the second program 9 generates new identification features, producing a new identification data record 7.2 in the process (block g, alternative g.a). The new identification data record 7.2 is saved in the comparison data record 9.1. Hence new identification features are assigned uniquely to the portable data storage device 4 for reusing in the future.

The second program 9 transmits the new identification data record 7.2 via the first communications channel 5 to the communications program 8 (block h, alternative h.a). This program sends the new identification data record 7.2 via the second communications channel 6 to the portable data storage device 4 (block i, alternative i.a), where the original identification data record 7.1 is replaced by the new identification data record 7.2 (block j). When the portable data storage device 4 is reused, the new identification data record 7.2 is then compared as the original identification data record 7.1 with the comparison data record 9.1.

With the transmission of the new identification data record 7.2 (block i), the data stored on the portable data storage device 4 is checked for the existence of malware.

Once the new identification data record 7.2 is saved on the portable data storage device 4, the second communications channel 6 is cleared for unrestricted data transfer between portable data storage device 4 and closed network 1 (block k). The first program 7 acknowledges to the communications program 8 by transmitting a verification signal that the new identification data record 7.2 has been saved successfully. The successful saving and the consequent opening of the second communications channel 6 is communicated by the communications program 8 to the first data processing device 2 as information for logging (not shown).

FIG. 1 also shows those alternative options of the method implementation according to the invention by means of which a data transfer between portable data storage device 4 and closed network 1 can be prevented.

If the portable data storage device 4 does not have an identification data record 7.1, this circumstance is detected by the communications program 8, and the second communications channel 6 is closed immediately (block f, alternative f.b). The communications program 8 issues information about the closure of the second communications channel 6 via the first communications channel 5 to the first data processing device 2. This information is saved in a log on the first data processing device 2 (not shown).

If the second program 9 does not establish any congruence between identification data record 7.1 and comparison data record 9.1, the second program 9 provides a blocking instruction 9.2 (block g.b) and transmits the blocking instruction 9.2 via the first communications channel 5 to the communications program 8 (block h, alternative h.b), whereupon the second communications channel 6 is closed (block i, alternative i.b).

### LIST OF REFERENCE NUMBERS

1 closed network

2 first data processing device (central computer)

3 first data processing device (peripheral device)

4 portable data storage device

5 first communications channel

6 second communications channel

7 first program (in the portable data storage device)

7.1, 7.2 identification data record

8 communications program (in the second data processing device 3)

9 second program (in the first data processing device 2)

9.1 comparison data record

9.2 blocking instruction

10 access computer for external data

1.-8. (canceled)

9. A method for secure use of a portable data storage device in a closed computer network that comprises at least two data processing devices connected to one another by a first communications channel, a first data processing device being a central computer of the closed computer network, and a second data processing device being a peripheral device, wherein the method comprises:
a) saving a comparison data record on the first data processing device, which comparison data record comprises at least information about all portable data storage devices approved for use at a current time, and wherein respective items of information in the comparison data record can be compared with data in a first identification data record,
b) saving a first identification data record on a portable data storage device, wherein identification features are added to the first identification data record that individually characterize the portable data storage device,
c) opening a second communications channel between the portable data storage device and the second data processing device solely for checking the existence of the first identification data record on the portable data storage device by the second data processing device (3),
d) checking the existence of the first identification data record on the portable data storage device, and either, in the event that the first identification data record does not exist on the portable data storage device, closing the second communications channel and continuing according to e), or, in the event that the first identification data record does exist on the portable data storage device, continuing according to e),
e) contacting the first data processing device via the first communications channel by the second data processing device, and either:
e1) transmitting information about a nonexistence of the first identification data record and transmitting information about the closure of the second communications channel to the first data processing device,
or
e2) transmitting the first identification data record, when it exists on the portable data storage device, to the first data processing device,
f) comparing the first identification data record transmitted in the case of e2) being performed with the comparison data record by checking for congruence between the first identification data record and the comparison data record, and either:
f1) if congruence is established, generating a new, second identification data record, wherein the second identification data record contains new identification features, and the second identification data record is adopted in the comparison data record,
or
f2) transmitting a blocking instruction by the first data processing device via the first communications channel to the second data processing device to close the second communications channel,
g) in the case of f1) being performed: clearing the second communications channel for transmitting the second identification data record to the portable data storage device after establishing a congruence between transmitted first identification data record and comparison data record, and
h) clearing the second communications channel for a data transfer between the portable data storage device and the second data processing device when the previous first identification data record in the portable data storage device has been replaced by the transmitted second identification data record,
wherein b) to h) can be executed repeatedly after a) has been executed once.

10. The method of claim 9, wherein all procedures performed in a) to h) are logged and retrievably saved.

11. The method of claim 9, wherein before the c), the first data processing device saves on the second data processing device a communications program for communication of the second data processing device with the first data processing device and with the portable data storage device, which communications program is used for checking the existence of the first identification data record on the portable data storage device and, in the event that the first identification data record does not exist on the portable data storage device, for closing the second communications channel.

12. The method of claim 11, wherein the communications program additionally comprises a routine for detecting and removing malware.

13. The method of claim 9, wherein identification features comprise at least one identifier of the portable data storage device and a password.

14. A portable data storage device having a rewritable memory, wherein a first identification data record is stored in a retrievable and editable manner on the portable data storage device, which first identification data record contains identification features that individually characterize the portable data storage device, and wherein the portable data storage device is not cleared for transmission of data other than first and second identification data records until a new, second identification data record is received and saved.

15. The portable data storage device of claim 14, wherein the portable storage device is a USB stick.

16. A closed network comprising at least two data processing devices connected to one another by communications channels, a first data processing device being a central computer, and a second data processing device being a peripheral device, wherein
on the second data processing device is installed a communications program:
i) for communication of the second data processing device with the first data processing device via a first communications channel, and with a portable data storage device connected via a second communications channel to the second data processing device,
ii) for checking the existence of a first identification data record on the portable data storage device, and
iii) for closing the second communications channel of the second data processing device in the event that the first identification data record does not exist;
on the first data processing device is stored a second program, which is used:
i) for communicating with the second data processing device,
ii) for performing a comparison and a check for congruence at least of identification features in the first identification data record that individually characterize the portable data storage device with a comparison data record saved in the first data processing device, wherein the comparison data record comprises at least information about all portable data storage devices approved for use at a current time, and respective items of information in the comparison data record can be compared with data in the first identification data record,
iii) for generating and providing a new, second identification data record when a congruence has been established, and
iv) for providing a blocking instruction to the second data processing device when congruence has not been established, wherein execution of the blocking instruction blocks the second communications channel.
